(19) United States
(12) Patent Application Publication
(10) Pub. No.: US 2022/0082429 A1
(43) Pub. Date: Mar. 17, 2022

(54) Method and apparatus for cookware weight management

(71) Applicant: Kitchen Robotics Ltd, Modiin (IL)

(72) Inventor: David BEN DAVID, Rehovot (IL)

(21) Appl. No.: 17/022,145

(22) Filed: Sep. 16, 2020

(51) Int. Cl. G01G 3/14; G05B 19/406; G01G 19/52; B25J 19/02

(52) U.S. Cl. CPC G01G 3/14; G05B 19/406; G05B 2219/31313; B25J 19/02; G01G 19/52

(57) ABSTRACT

The present invention is a method of measuring a cookware weight in robotic or automatic systems for commercial kitchens, or dark kitchens, or ghost kitchens, or could kitchens. The said invention applies single axis and multiple axes motion system and strain gauge load cell to convert changes in output voltage into converted readable values.

### FIELD OF THE INVENTION

The present invention is a method of measuring a cookware weight in robotic or automatic systems for commercial kitchens, or dark kitchens, or ghost kitchens, or could kitchens. Moreover, the said invention uniquely applies single axis and multiple axes motion system and strain gauge load cell in undertaking the task.

### BACKGROUND OF THE INVENTION

In a robotic or automatic cooking environment, cookware weight control is an essential prerequisite for processes such as ingredient collection, real-time feedbacks and system diagnostics. Load-cells are widely used as a force or weight sensors, due to their durability and proven reliability in operating in harsh working conditions. Being a cost effective and relatively accurate measuring component, strain-gauge load cell is often selected.

Strain gauge load cells are a type of load cell where a strain gauge assembly is positioned inside the load cell housing to convert the load acting on them into electrical signals. The weight on the load cell is measured by the voltage fluctuation caused in the strain gauge when it undergoes deformation. Thus, the technique finds application in a plurality of applications where weight measurement, especially over a wide range have to be calculated.

Various inventions that have been patented in this field are as follows:

U.S. Pat. No. 4,711,314A titled, “Multi-range load cell weighing scale” talks of a multi-range load cell weighing scale that includes a load receiving pan provided at the top of a casing, a high-range load cell disposed in the casing for a high range of weight determination, and a low-range load cell disposed in the casing for a low range of weight determination in a substantially horizontally juxtaposed relation to the high-range load cell. The low-range load cell has one end connected to one end of the high-range load cell. The other end of the high-range load cell is supported on the bottom of the casing, while the other end of the low-range load cell defines a load support on which the pan is supported. The load to be weighed bears on the two load cells simultaneously. The scale enables a wide range of highly accurate weight determination, despite its use of inexpensive load cells.

U.S. Pat. No. 6,636,820 titled, “Method and apparatus for measuring weight using uncalibrated load cells” talks of a method and apparatus for calibrating load cells in the filed after the uncalibrated load cells have been installed. Two known weight conditions are used in conjunction with a storage device in which the uncalibrated load cells are installed. The method will calibrate the load cells, calculate load cell offsets, scale factor differences between load cells, and flexure/stresses in a supporting structure which rests upon the uncalibrated load cells.

U.S. Pat. No. 9,400,208 titled, “Load cell and method for adjusting a load cell” talks of load cell, which includes a weighing system having a force application point, a load boom arm for receiving the loads to be weighed at a position remote from the force application point and an adjusting device, wherein an adjusting weight boom arm is provided which extends in a longitudinal direction defined by the load boom arm on the side opposing the load boom arm relative to the force application point and which has at least two pre-determined adjusting weight engagement points. An activating unit places at least one adjusting weight on at least one of the adjusting weight engagement points.

While patents stating weight calculation through usage of load cells are in vogue, such application in cooking, especially in automated/robotic environment where, the need for precise weight measurement is considered key to apt functioning remains elusive. The present invention is an effort to apply the load cell weight determination concept in an automatic and robotic cooking environment to enable undertakes a smooth and flawless cooking process.

### SUMMARY OF THE INVENTION

An aspect of the invention is to provide a method for measuring the weight of a cookware, in robotic or automated systems whereby single axis or multiple axes motion system are employed.

A still further aspect of the invention is the method for measuring the weight of a cookware using a strain gauge load cell to convert changes in output voltage into converted readable values.

A still further aspect of the invention is the method of measuring weight of a cookware by employing a mechanism, which eliminates all force vectors applied on the load-cell, except the force vector indicating the cookware weight.

A still further aspect of the invention in the weight measurement of a cookware is the application of a mechanism for preventing damage to the strain gauge load-cell, causing faulty measurements or failure.

A further aspect of the invention is the accurate measurement of the weight of a cookware using a strain gauge load cell without any external inference by thermally insulating the strain gauge load-cell so as to prevent heated cookware from influencing the load cell thereby influencing its weight.

A further aspect of the invention is thermal insulation of the strain gauge load-cell which is achieved by constructing the mechanism from thermally insulating materials, such as, viton, silicone and polyurethane.

Another aspect of the invention is a method of measuring the cookware weight while the cookware is inclined by a specific angle especially during ingredient collection from an ingredient dispenser, which requires tilting of the cookware to a predefined angle.

A further aspect of the invention is to execute the above aspects by providing an apparatus comprising a stationary base which might be fixed to a motion system or robotic arm and a strain gauge load cell fixed to the stationary base of the mechanism.

### BRIEF DESCRIPTION OF THE DRAWINGS

The present invention will become more fully understood from the detailed description and the accompanying drawing. The drawing constitutes a part of this specification and includes exemplary embodiments of the invention, which may be embodied in various forms. In addition, in the embodiments depicted herein, like reference numerals in the drawing refer to identical or near identical structural elements.

FIG. 1 Cookware mounting or gripping mechanism, containing and strain gauge load-cell.

### REFERENCE NUMERALS

101 strain gauge load-cell
102 mounting mechanism stationary base
103 force vector applied on the load-cell
104 force applied by the cookware weight
105 pivot axis

### DETAILED DESCRIPTION OF THE PREFERRED EMBODIMENTS

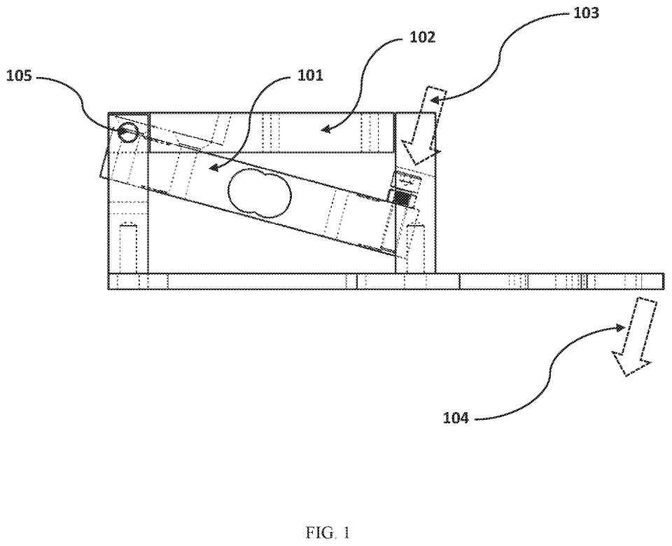

The preferred forms of the invention will now be described with reference to FIG. 1. The appended claims are not limited to the preferred forms and no term and/or phrase used herein is to be given a meaning other than its ordinary meaning unless it is expressly stated that the term and/or phrase shall have a special meaning.

The present disclosure is directed to accurate measurement of the weight of cookware in a smart cooking device and accompanying systems and software deploying single/multiple axes motion system for fulfilling one or more cooking events that can occur during cooking of food. In accomplishing the objective, the cookware utilizes strain gauge load cells 101 as a force transducer. The said transducer converts a force such as tension, compression, pressure, or torque into an electrical signal that can be measured and standardized. As the force applied to the load cell 101 increases, the electrical signal changes proportionally that thereupon gets translated into readable values.

Hence, in a further embodiment the said cookware is either in mounted or gripped state and is laced with load-cell 101. When the cookware weight changes during collection of food ingredients in robotic systems) the load-cell undergoes a deformation causing a voltage fluctuation in the strain gauge. The change in output voltage is thereby measured and converted into readable values using a digital meter.

In an automated/robotic cooking environment, functions such as picking up the cookware, inserting the cookware to a cooking apparatus or supporting the cookware during a washing cycle, exposes the cookware gripping mechanism, to various loads, when water pressure is applied. More so, while picking up the cookware, impact loads are applied to the gripping mechanism by the surrounding sub-systems in contact with the cookware. Mostly these are frictional forces, preventing the cookware from being picked up. Thus, the gripping mechanism, when exposed to these forces, must prevent them to be applied to the incorporated load-cell. In case the force applied on the strain gauge exceeds the allowed value, it might cause the load-cell to fail. Thus, it becomes pertinent to embody a mechanism for accurate measurement of the voltage fluctuation in such a situation.

Furthermore, weight measurement accuracy of the cookware manipulated by single or multiple axis motion system is compromised by forces generated from the motion profile, impacts and friction. Moreover, the load-cell measuring device might be exposed to stresses exceeding the allowed values. Such a case might occur during impacts of the cookware or friction. Since the cookware is mounted or gripped directly on the load-cell, serving as a weight sensor, most of the impacts and forces applied on the cookware are projected on the load-cell as well, causing faulty weight measurement or even permanent damage of the load-cell.

To overcome the above negating factors, the mechanism deployed for accurate measuring of the weight of the cookware involves negating the deformation vectors by absorbing torques, loads and force vectors which are not in the same direction to the strain gauge, thereby allowing only the force vectors that are indicators of the weight to influence the output voltage. The deformation forces described above are absorbed by the cookware mounting or gripping mechanism, since the cookware is physically mounted on the mechanism itself, rather than on the load cell. The mechanism allows only one degree of freedom, applying a single directional force vector, more so, the weight indicating force vectors on the strain gauge load-cell. Further, as the opposing loads, not in the same direction as to that vector, apply stresses on the mechanism, hence, appropriate design of the cookware mount and grip have been incorporated to withstand them.

Thus, in some embodiments, the cookware mount is designed in a way to prevent stress-causing forces to negatively influence the cookware weight. Thus, the cookware is incorporated with a stationary base 102 which might be fixed to a motion system or robotic arm. Besides, the strain gauge load cell 101 is fixed to the stationary base 102 of the mechanism. Moreover, all other parts of the cookware gripping mechanism described above is designed in a way to create typical geometrical shapes that are free to rotate above a pivot 105 with the axis of the pivot being parallel to the load-cell cross section. As all the bodies can freely rotate along the pivot, applying a vector of force 103 on the load-cell 101 does not create any negating influence.

Also, the cookware gripping mechanism has a rotational degree of freedom around to the pivot axis as described in FIG. 1. Wherein, the strain gauge load-cell serves as a hard stop limiting the rotation. The hard stop limit can be calibrated by an adjustment screw, secured by a locking nut. The screw is adjusted to achieve a minimal degree of rotational movement of the cookware gripping mechanism, such as 0.01 degrees, or less. The adjustment can be achieved by an accurate gap measurement by filler gauge. Hard stop limit calibration is essential to reduce to minimum, the movement range of the cookware on the gripping mechanism. Minimal movement range reduces impacts that might be harmful to the strain gauge load-cell. Additionally, the screw and nut adjustment mechanism can eliminate the rotational degree of freedom and the movement range completely, by applying a constant preload to the strain gauge load-cell. This setup might be preferred in high accuracy applications.

Further embodiment states that the above mentioned mechanism can be calibrated in a way so as to absorb strains, when such strain exceeds the critical strain values allowed by the load-cell so as enable accurate measurement of the cookware weight.

To negate any influence of heat on the calculation of the cookware weight, the cookware are mounted or gripped on the gripping mechanism, containing the load-cell, so that heat convection to the load cell does not result in thermal expansion, deformation, and affect the weight measurement accuracy. Also, since the cookware is mounted directly on the gripping mechanism, the load-cell can be thermally insulated. The thermal insulation can be achieved by constructing the mechanism from thermally insulating materials, such as, Viton, Silicone and Polyurethane.

In another embodiment of the present invention, the cookware weight in a robotic or automated system is determined in an inclined position wherein the ingredient collection might require tilting the cookware at a predefined angle, for example, when engaging it towards a food ingredient dispenser. To take care of the situation, the mechanism for gripping the cookware, containing the strain gauge load-cell, can be preset to measure the cookware weight with accuracy specified by the load-cell, while the cookware is tilted to a specific angle. The load-cell can be mounted on the mechanism by an angle similar to the preset tiling angle of the cookware, thus being in a horizontal position, ideal for accurate weight measurement, while the cookware is tiled or inclined.

The present disclosed subject matter may be a system, a method, and/or a computer program product. The computer program product may include a computer readable storage medium (or media) having computer readable program instructions thereon for causing a processor to carry out aspects of the present disclosed subject matter. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming langauges, including an object oriented programming langauge such as Smalltalk, C++ or the like, and conventional procedural programming langauges, such as the “C” programming langauge or similar programming langauges. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter. Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The FIGURES illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. An apparatus for cookware weight management in automated robotic systems, the cookware comprising:
a strain gauge load cell;
a stationary base; and
a pivot axis;
wherein,
the said parts are free to rotate above the said pivot with the axis of the said pivot being parallel to the load-cell cross section, and
wherein,
the said strain gauge load cells are utilized as a force transducer for converting a force such as tension, compression, pressure, or torque into an electrical signal translating into readable values which is reflected on a digital meter.

2. An apparatus of claim 1, wherein the said load-cell is thermally insulated to prevent thermal expansion and deformation.

3. An apparatus of claim 2, wherein the said load cell and the apparatus is made of insulating materials.

4. An apparatus of claim 3, wherein the insulating materials are Viton, Silicone and Polyurethane.

5. An apparatus of claim 1, wherein the cookware weight is measured accurately, while the cookware is tilted at a specific angle.

6. An apparatus of claim 5, wherein the measurement of the tilted cookware is accomplished by mounting the load cell on the mechanism at an angle similar to the tilted cookware.

7. A method of accurately measure cookware, in robotic systems deploying single/multiple axes motion system, the method comprising:
incorporating the cookware fixed to the robotic arm with a stationary base and a strain gauge load cell;
providing a pivot wherein, the axis of the pivot is parallel to the load-cell cross section;
providing a strain gauge load cell with the cookware gripping mechanism having rotational degree of freedom,
wherein,
the said strain gauge load cell acts as a hard stop limiting the rotation around the said pivot axis;
measuring the change in output voltage and converting the voltage fluctuation into readable values, upon change of cookware weight during collection of food ingredients;
wherein,
the strain gauge cells acts as a force transducer converting the forces into a readable electrical signal.

8. The method of claim 7, wherein the said hard stop limitation is calibrated by an adjustment screw, secured by a locking nut.

9. The method of claim 7, wherein the minimum degree of rotational limit of the cookware gripping mechanism achieved is less than 0.01 degrees.

10. The method of claim 7, wherein the method further comprises mounting the load-cell in a specific angle on the system, similar to that of the cookware for measuring the cookware weight accurately in tilted angle.

11. The method of claim 7, wherein the method comprises thermal insulation of the load-cell for accurate weight measurement of a heated cookware.
